(19) United States
(12) Patent Application Publication
(10) Pub. No.: US 2006/0023656 A1
(43) Pub. Date: Feb. 2, 2006

(54) Interactive digital data broadcasting system

(76) Inventor: Richard L. Anglin JR., Del Mar, CA (US)

Correspondence Address: Thomas N. Giaccherini, Post Office Box 1146, Carmel Valley, CA, 93924, US

(21) Appl. No.: 10/909,110

(22) Filed: Jul. 29, 2004

(51) Int. Cl. H04Q 7/00

(52) U.S. Cl. 370/328

(57) ABSTRACT

An Interactive Digital Data Broadcasting System comprises a plurality of digital data broadcasting transmitter systems (12) is disclosed. In a preferred embodiment, the transmitter (12) operate in the frequency bands 2,310-2,320 and 2,345-2,360 MHz (S-band), 902-928 MHz, 2,400-2,483.5 MHz or 5,725-5,825 MHz. The present invention also includes user terminal (14) capable of receiving a plurality of channels in the said frequency bands and capable of transmitting in one or more traditional wireless communications bands; a plurality of receiving systems (16) for transmission from a user terminal (14); and a network management center (18). A user terminal (14) comprises an antenna system (20) capable of receiving multiple channels of broadband data broadcast transmissions in said frequency bands 2,310-2,320 and 2,345-2,360 MHz, 902-928 MHz, 2,400-2,483.5 MHz or 5,725-5,825 MHz (22) and transmitting on any traditional wireless communications technology (24) or via the transmitted band; a receiver (26); digital signal processing (28); a user interface (30); a transmitter operating in a traditional wireless communications system band (32); and a software operating system (34) to control the functions of the user terminal (14).

### CROSS-REFERENCE TO A RELATED PATENT APPLICATION & CLAIM FOR PRIORITY

The present Patent Application is a Continuation-in-Part patent application. The Applicant hereby claims the benefit of priority for any subject matter which is shared by the present Application, and by a pending commonly-owned Parent application entitled Interactive Digital Data Broadcasting System, which was filed on 3 Oct. 1997, and which was assigned U.S. Ser. No. 08/943,987.

### FEDERALLY SPONSORED RESEARCH OR DEVELOPMENT

Not Applicable.

### FIELD OF THE INVENTION

The present invention relates to the field of wireless mobile data communications and broadcasting. More particularly, this invention provides novel methods and apparatus for broadcasting digital data, including digital audio and video, programming to mobile, portable and fixed receivers and for receiving digital transmissions from those user terminals. Utilization of the present invention will create new markets for wireless access to the Internet, including interactive data, audio, image and compressed video, both on a subscription and advertizer-supported basis.

### BACKGROUND OF THE INVENTION

Wireless communication systems such as cellular, Personal Communication System (“PCS”) and satellite systems such as Iridium and American Mobile Satellite Corporation (“AMSC”) have all been implemented and deployed to enable mobile voice communications. Technologies for these systems, whether analog or digital, have evolved from the voice handling requirements of the Public Switch Telephone Network (“PSTN”). Virtually all of these systems are narrowband because of the limited radio frequency (“RF”) spectrum available to each service. The channels are sized to the minimum bandwidth required to support “acceptable” voice communications. “Acceptability” means intelligibility and clarity, not necessarily the “toll” quality of the PSTN. All of these systems are symmetric, that is, two channels of equal size are required to support full-duplex voice communications.

The system parameters that are required to deliver voice services make handling digital data communications difficult. All of these systems accommodate wireless digital data communications, but the data throughput rates are very low and the additional equipment required can be complex because of the network switching requirements.

The advent of the Internet has ushered a fundamental paradigm shift in the way in which information is collected, stored, displayed, accessed and distributed. The Internet has taken over, with the Web browser rapidly becoming the user template for communications, information and even entertainment. This feature-rich multimedia environment has led to bandwidth demands which traditional wireline telecommunications networks struggle today to meet.

For example, information formerly presented in catalogs resides in World Wide Web (“WWW” or “Web”) sites and is available for viewing via a Web browser, printing to a local printer or downloading as a file to a local personal computer (“PC”). Electronic mail (“e-mail”) has become the de rigeur for business and is widely used by consumers.

The historical model of centralized corporate information databases has been replaced by dispersed local servers interconnected via high-speed telecommunications networks. The increasing mobility and globalization of business requires virtually instantaneous access to this information wherever it may reside. Mobile workers are expected to have the same access as workers in fixed locations. Go to any major airport in the world and observe countless travelers toting laptop PCs. In seeking to make waiting time productive they are constantly looking for data ports to plug in their laptops to access the Internet.

Wireless communications carriers, terrestrial and satellite, are today seeking technologies to support this major paradigm shift to the Internet. They are constrained, however, by the narrowband, low speed, symmetrical character of deployed wireless communication systems.

Eavesdrop on any conversation about the Internet and the topic of access speed invariably comes up. The great majority of people are talking about access speed at their business or home. Access speed is addictive. Once having access to higher Internet speeds, users resist, often to the point of avoidance, lower speed technologies (even for just e-mail). When it comes to wireless Internet access there are no high speed alternatives.

Consider a typical mobile Internet session. The user logs onto the Internet and first requests download of his or her e-mail messages. The request to the electronic mail server is a very small message. The download can be quick if there are only a few messages and the messages themselves are small. However, if there are a large number of messages or the messages contain a large amount of text, downloading can take a very long time. Downloads are even slower if the messages have files appended to them, and slower still if the files are graphic images or video.

This user is a corporate salesperson and needs to download a product brochure. Again, the request to the database server is a small message, but the download file is large. The download process maybe extremely slow if the file contains embedded images in color.

In the United States, several organizations are developing technologies to allow digital signals to be simultaneously broadcast within the same frequency band and on the same channel as existing amplitude modulation (“AM”) and frequency modulation (“FM”) radio stations, that is, in-band, on-channel (“IBOC”), and technologies to simultaneously transmit digital signals in the same band but in a non-interfering channel adjacent to a FM channel, that is, in-band, adjacent channel (“IBAC”). This technology, if implemented, would allow existing broadcasters to provide a single, or perhaps a few, channels of compact disk (“CD”) quality digital programming within the area they currently serve and without additional frequently allocations. In recent comparative testing these systems did not fare well and must be redesigned. Considerable more development and testing is necessary for these systems even to be considered for deployment. Even then, as with exiting AM and FM, these technologies are single fixed broadcast channels without interactive capability.

On Apr. 1, 1997, the Federal Communications Commission (“FCC”) auctioned two licenses to provide satellite-based digital audio radio services (“S-DARS”) in the United States. Satellite CD Radio, Inc. (“SCDR”), now Sirius Satellite Radio, Inc. (NASDAQ symbol “CDRD”), and American Mobile Radio Corporation (“AMRC”), a subsidiary of AMSC, now XM Corporation, were the winning bidders for the two available licenses in this service respectively (2,320-2,332.5 MHz and 2,332.5-2,345 MHz). Because these are satellite-based systems only, some years are required for either of them to commence service. Depending upon the final design of each system, they may offer multiple channels on a nationwide basis only. These DARS systems will not offer regional or local services. Furthermore, they do not provide interactive capability and they do not utilize Internet Protocol (“IP”).

Radio Satellite Corporation (“RadioSat”) has developed a patented broadcast, navigation and communication system which could be implemented using only narrowband L-band mobile satellite services (“MSS”) available from AMSC in the United States and TMI, Inc. in Canada. The RadioSat mobile terminal is conceptually designed to deliver a few channels of digital audio and interactive data services, including global positioning system (“GPS”) information. RadioSat has been actively pursuing opportunities to implement its services but has had no success in almost a decade of trying.

A number of both terrestrial and satellite mobile data systems exist, all of which systems are fixed narrow bandwidth and limited capacity. None of these systems offer or are likely to offer broadband or high-speed access to the Internet or the Web, or audio, image or video services because of both bandwidth and regulatory limitations. Further, these systems are focused on commercial applications only such as fleet management and routing, not entertainment or information services. Examples of such mobile data systems include: Cellular Digital Packet Data (“CDPD”), RAM Mobile Data (“RAM”), now Bell South Mobile Data System (“BAM”), Advanced Radio Data Information Service (“ARDIS”), now owned by AMSC, Metricom Ricochet service, TMI, Qualcomm, Inc. OmniTRACS®, two-way paging systems such as SkyTel, and the “Big LEO” and “Little LEO” satellite systems. All of these systems offer only very low speed data communications, most under 30 kbps (although many claim higher speeds).

No system exists today which provides dynamically allocated asymmetrical digital data communications services to mobile users. The development of a system that provides on-demand, high-speed wireless data communications and broadcast transmission to and from mobile users would contribute an important advancement in the telecommunications industry. Such asymmetrical IP transmission capability would respond to and support a variety of interactive applications, such as Internet and Web access and multi-channel interactive information and entertainment programming, including audio, image and video.

There is a tremendous and rapidly increasing need for a wireless communication system to support high speed mobile digital data communications. The desired system should be asymmetric; providing high bandwidth for downloading information and small bandwidth for uploading message requests and electronic mail. However, high bandwidth should also be available if the user needs to upload a large file. Thus, the desired wireless digital data communications system should be able to dynamically allocate bandwidth to users to accommodate their particular requirements at any given point in time.

### SUMMARY OF THE INVENTION

The present invention encompasses methods and apparatus to enable high-speed broadband wireless digital data communications to and from mobile users. The disclosed invention can provide a variety of interactive information, entertainment and data services, including audio, image and compressed video to mobile users. The disclosed invention responds to increasing mobility and demands for real-time information.

The present invention offers a number of synergies and advantages. First, all existing two-way mobile communications technologies are narrow-band, fixed bandwidth and symmetrical, that is, out-bound and in-bound channels are of equal size. The disclosed invention is asymmetrical, the out-bound transmission to the mobile user is much higher in bandwidth than the in-bound channel for downloading information, and opposite for uploading. Further, the bandwidth is variable on demand; it can be tailored to meet service requirements.

Second, in the most preferred embodiment by using the Industrial, Scientific and Medical (“ISM”) frequency bands, no further license is required from the FCC. Only Part 15 type acceptance of terminal equipment is required.

Third, the disclosed invention enables wireless broadband access to the varied multimedia content of the Internet and WWW.

Fourth, the disclosed invention enables a variety of audio, data, image and compressed video services primarily to mobile users heretofore unavailable.

Instead of being transmitted at fixed, compressed data rates, channels will continuously be transmitted at optimal data rates to guarantee the desired quality perceived by listeners. A preferred audio entertainment and information embodiment of the disclosed invention comprises a number of broadcast “FM quality” channels of audio programming at 64 kbpg as well as several “CD quality” channels at 128 kbps. For example, a classical channel would broadcast a symphony at 128 kbps and news segments at 64 kbps while maintaining the same perceived quality.

To enable subscription-based services and multiple listeners per subscription, a preferred embodiment of the disclosed invention utilizes subscriber identity module (“SIM”) technology. SIM cards the size of a credit card will contain subscriber characteristics and programming choices and will enable subscribers to listen to their preferred programming regardless of the receiver used.

RealNetworks, Inc. has deployed RealAudio™ and RealVideo™, methods of transmitting audio and video programming respectively via the Internet using Transmission Control Protocol/Internet Protocol (“TCP/IP”). An alternative embodiment of the disclosed invention comprises application of this and similar transmission protocol technologies to the mobile environment.

Among other data services a preferred embodiment of the disclosed invention enables transmission of an Electronic Program Guide (“EPG”) to all receivers. This guide provides information on current and forthcoming programming or special events available via the disclosed invention.

Because the present invention integrates wireless Internet access with audio, image and video broadcasting, the listener can be drawn into an interactive environment. A preferred embodiment of the disclosed invention enables transmission of program selection, composer and other information as an integral part of the audio broadcast. Additionally, in an alternative embodiment of the disclosed invention, if the program is taken from a CD, the listener is able to purchase that CD and have it delivered to his home or office simply by pushing a “button” on the receiver touch-screen. A further alternative embodiment of the disclosed invention, enables the listener to access a database or other works by the same composer and order them as well.

Alternative embodiments of the invention enable a number of interactive information services unrelated to audio, image and video programming. For example, the invention maybe used to provide continuous stock and bond quotations selected by the subscriber. Through strategic relationships with stock brokers, a further alternative embodiment of the disclosed invention can even enable trades.

The FCC has mandated that wireless communications systems implement technologies to provide location information to be used by enhanced 911 (“E911”) systems in responding to emergency situations. Location information derived from a GPS receiver may be used to provide a number of value-added data and information services via the disclosed invention. For example, the disclosed invention may be used to provide directory information about restaurants, hotels, attractions and other traveler services specific to the area of the caller upon request.

A further alternative embodiment of the disclosed invention comprises receivers including a screen for the display of images or video. The screen may be used to display maps, weather forecasts or other graphic information. A further alternative embodiment of the disclosed invention comprises a thermal printer for hard copies of transmitted or displayed information.

An appreciation of the other aims and objectives of the present invention and a more complete and comprehensive understanding of this invention may be obtained by studying the following description of a preferred embodiment and by referring to the accompanying drawings.

### BRIEF DESCRIPTION OF THE DRAWINGS

FIG. 1 shows the elements of the Interactive Digital Data Broadcasting System.

FIG. 2 shows elements of the disclosed invention with a variety of user terminals.

FIG. 3 shows asymmetrical bandwidth for outbound (download) and inbound (upload) transmissions.

FIG. 4 shows dynamic allocation of bandwidth over time for both outbound and inbound transmissions.

FIG. 5 shows the same digital information encoded on multiple radio frequencies emanating from a single base station.

FIG. 6 shows a frequency bandwidth plan for a traditional wireless communications system.

FIG. 7 shows a cell coverage pattern for a traditional wireless communications network.

FIG. 8 shows a base station simultaneously transmitting on three radio frequencies.

FIG. 9 shows three (3) coverage areas from a base station simultaneously transmitting on three (3) radio frequencies.

FIG. 10 shows signaling channels within multiple frequency bands.

FIG. 11 shows a PC card receiver, transmitter, modem and antenna for a laptop computer.

FIG. 12 shows a PCI card receiver, transmitter, modem and antenna for a desktop computer.

FIG. 13 shows a PCI card receiver, transmitter, modem and remotely mounted antenna for a desktop computer.

FIG. 14 shows a receiver, transmitter, modem and antenna for a Personal Digital Assistant (“PDA”).

FIG. 15 shows an alternative form factor receiver, transmitter, modem and antenna for a PDA.

FIG. 16 shows a block diagram for a user terminal installed in a vehicle.

FIG. 17 shows a block diagram for a user interface for a terminal.

FIG. 18 shows an audio user terminal embodiment of the disclosed invention.

FIG. 19 shows an image and video embodiment of the disclosed invention.

FIG. 20 shows an alternative embodiment of the disclosed invention wherein inbound communications from a user terminal are via a traditional wireless communications system.

FIG. 21 shows a block diagram for a user terminal for an alternative embodiment of the disclosed invention wherein inbound communications from a user terminal are via a traditional wireless communications system.

FIG. 22 shows an electronic commerce alternative embodiment of the disclosed invention.

FIG. 23 shows an embodiment of the disclosed invention utilizing a satellite for communications.

### DETAILED DESCRIPTION OF PREFERRED & ALTERNATIVE EMBODIMENTS

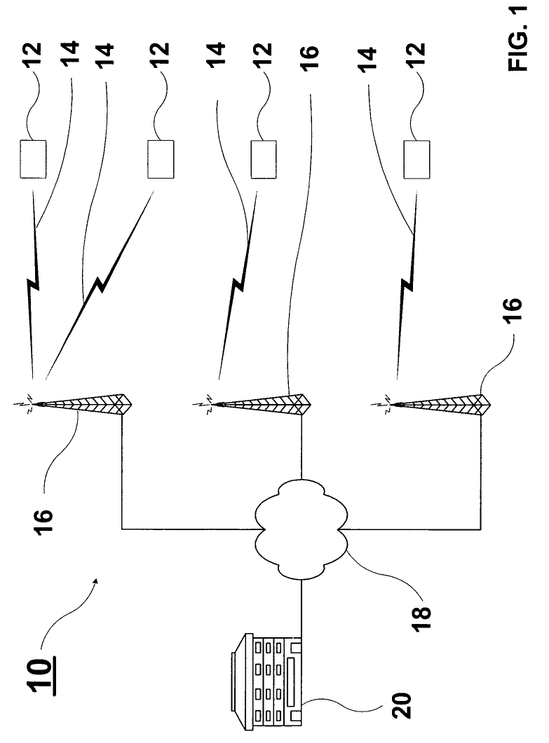

The elements the Interactive Digital Data Broadcasting System 10 are shown in FIG. 1. A plurality of user terminals 12 communicate via a plurality of wireless air interfaces 14 to a plurality of base stations 16. The base stations 16 are connected via the Internet 18 to a Network Management Center (“NMC”) 20.

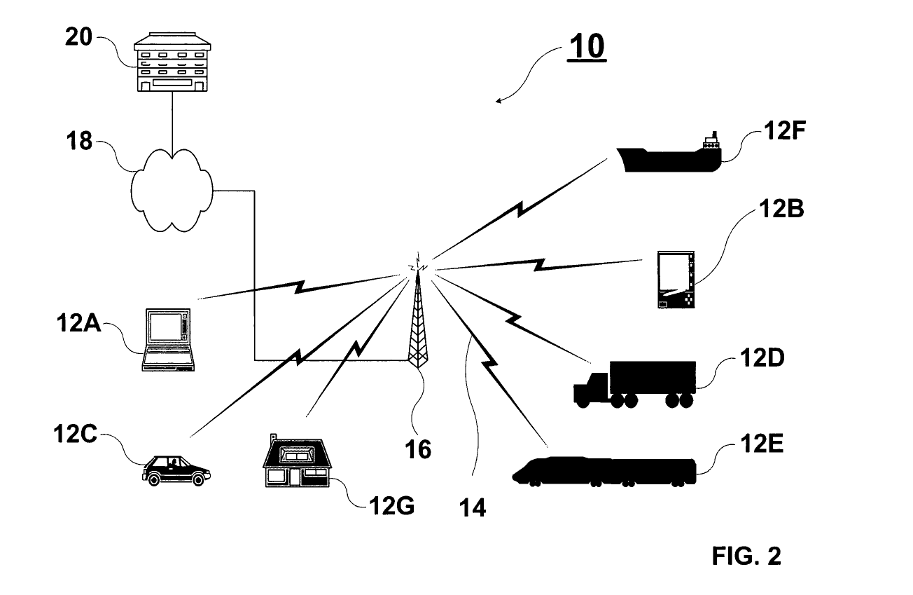

The variety of possible user terminal 12 configurations is shown in FIG. 2, ranging from a laptop computer 12A, Personal Digital Assistant (“PDA”) 12B, to a terminal installed in an automobile 12C, in a truck 12D, on a train 12E, on a ship or boat 12F, or a fixed terminal 12G. The terminals can be use for a variety of data, audio, image and video services.

Air Interface

The air interface 14 can be any wireless communications technology from analog AM or FM to digital techniques such as IBOC, IBAC, Time Division Multiple Access (“TDMA”), including Global System for Mobile (“GSM”), Code Division Multiple Access (“CDMA”), as well as other waveforms. Some of these waveforms may be limited to one-way broadcasts. In the most preferred embodiment of the disclosed invention 10, a chirping waveform is used. Chirping waveforms are described in the pending patent applications entitled Chirping Digital Wireless System, which was filed on 15 Dec. 1998, and which was assigned U.S. Ser. No. 09/212,339, and Chirp Waveform Decoding System, which was filed on 25 Jun. 1999, and which was assigned U.S. Ser. No. 09/344,086.

Network Characteristics

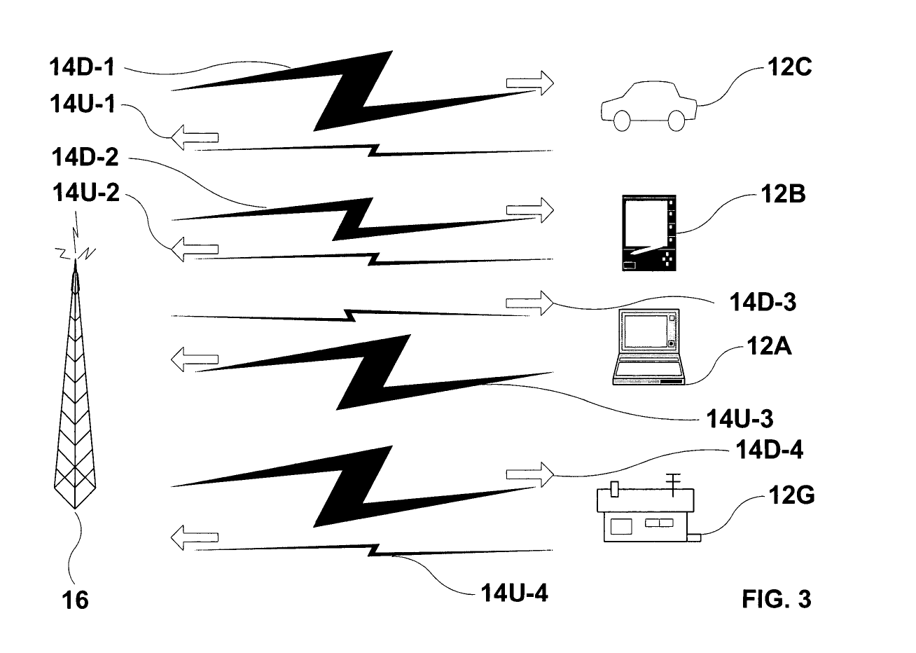

The disclosed invention 10 comprises a number of distinctive and advantageous characteristics. First, while the air interface 14 can comprise fixed symmetric bandwidth, that is, outbound (download) channels from a base station 16 to a user terminal 12 equal in size to inbound (upload) channels from a user terminal 12 to a base station 16, as shown in FIG. 3 the channels are asymmetric in the most preferred embodiment of the disclosed invention 10.

For example, automobile terminal 12C user receives the outbound transmission 14D-1 of CD audio music at 256 kbps from the base station 16. If the automobile terminal 12C user wishes to purchase the CD from which the transmission 14D-1 is taken, he or she send a brief message 14U-1 to effectuate the order. The inbound transmission 14U-1 could be only 32 kbps.

A PDA 12B user will most likely be accessing his or her e-mail. The initial request 14U-2 to the e-mail server is a small message, requiring only limited bandwidth. The download 14D-2 can be quick if there are only a few messages and the messages themselves are small, 128 kbps to 256 kbps likely sufficient.

The asymmetry is not limited to larger bandwidths for outbound transmissions. A laptop computer 12A user can be allocated larger bandwidth 14U-3 for uploading large files, for example, 384 kbps to 512 kbps to more than 2 Mbps.

The disclosed invention 10 may also be used in fixed applications such as delivering digital television to homes or other fixed location terminals 12G. Here the outbound transmission 14D-4 can be several megabits. The inbound transmission 14U-4 can be quite small, 32 kbps, to request pay-per-view (“PPV”) programming or to order products.

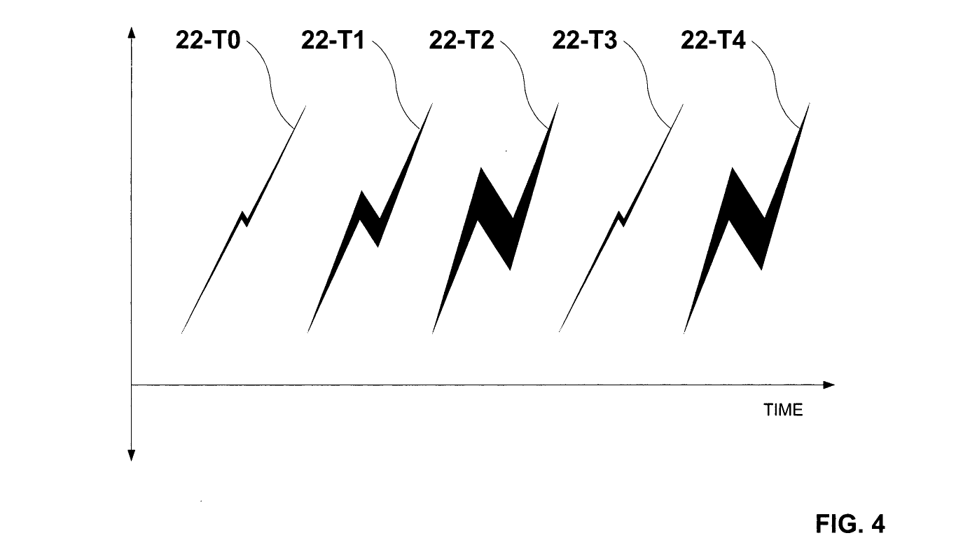

Further, the outbound and inbound bandwidth can be variable; it can be tailored to meet service requirements. That is, the outbound and inbound bandwidth can be allocated dynamically, allocated in time in response to user demand as shown in FIG. 4. A transmission can be initiated at a very low data rate such as 32 kbps 22-T0, in the next time interval increase to 128 kbps 22-T1, in the next interval increase to more than a megabit 22-T2, in the next interval drop back to the initial data rate of 32 kbps 22-T3, in the next interval jump back to more than a megabit 22-T4. Furthermore, the time intervals do not have to be fixed as is required in some traditional digital wireless communications systems. Existing wireless communications systems cannot dynamically allocate bandwidth.

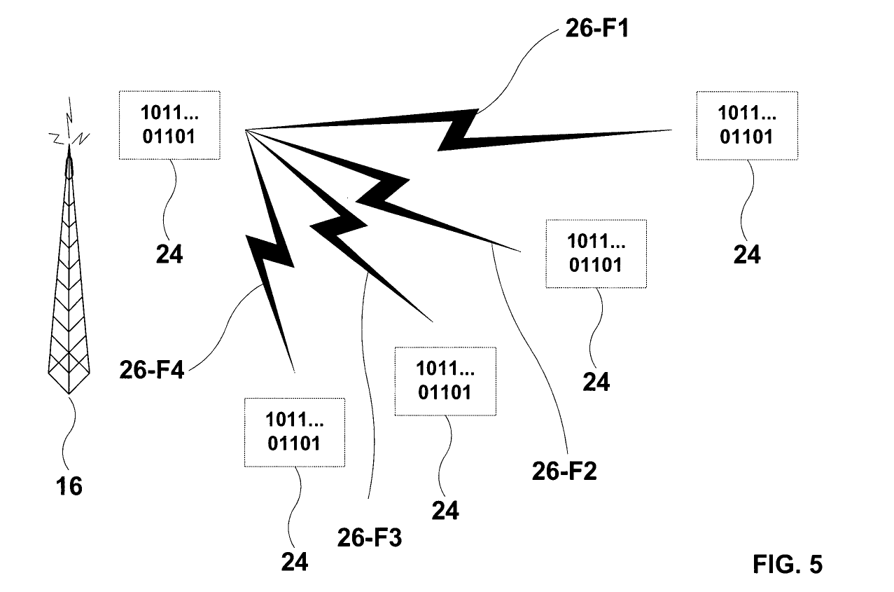

A further advantage of the disclosed invention 10 is that the same digital input 24 can be simultaneously impressed upon multiple RF frequencies without interfering with the information content of the digital data and without the need for channelization as is required in traditional wireless communications systems. FIG. 5 shows a multicast application, that is, digital data 24 impressed upon multiple frequencies 26-F1 through 26-F4.

A major frustration of users of traditional wireless systems is the “dropped call,” an unexpected and unwanted disconnect of communications resulting from the configuration of the network or resulting from a lack of adequate link margin between the cellular or PCS base station and the cellular or PCS telephone.

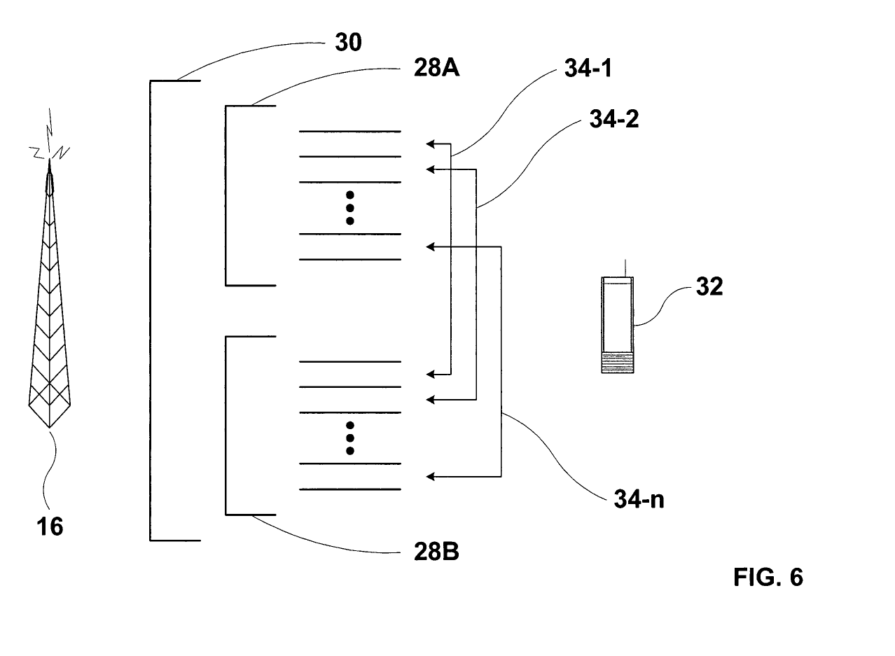

Traditional wireless communications systems are licensed for a specified amount of bandwidth 28 in a particular frequency band 30 as shown in FIG. 6. Usually, two (2) separated equal blocks of bandwidth are assigned; one 28A for transmissions from a base station 16 to a cellular or PCS phone 32, the other 28B for transmissions from a cellular or PCS phone 32 to a base station 16. The blocks 28A, 28B are then channelized and paired 34-1, 34-2, . . . 34ᵢ, 34ⱼ, . . . 34-n to enable full duplex communications. The number of possible duplex channels 34-1 . . . 34-n is a function of the total available bandwidth blocks 28A, 28B and the channel bandwidth required by a particular cellular or PCS technology.

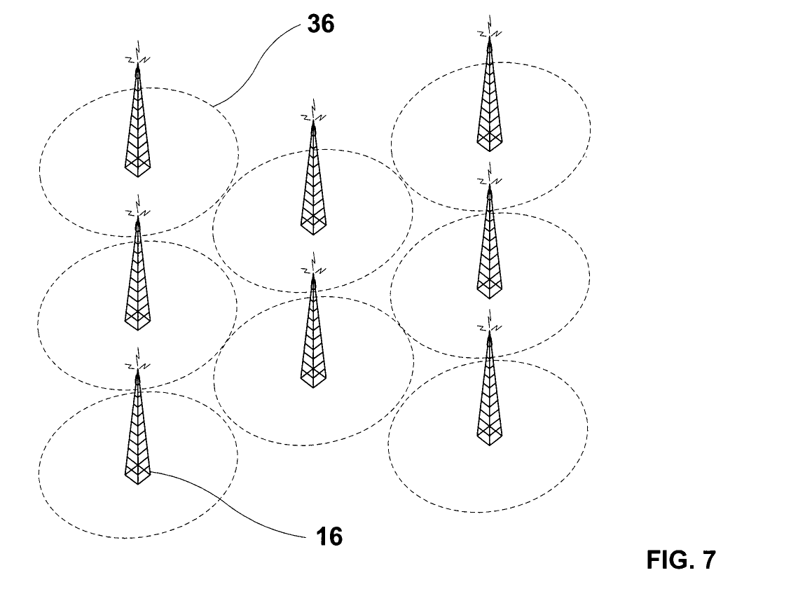

The design principles of traditional wireless communications networks are well established. A plurality of base stations 16 provide transmissions within a plurality of cells 36, as shown in FIG. 7. As a cellular or PCS phone 32 traverses the coverage area, the plurality of cells 36, his or her transmissions are automatically “handed off” from one base station 16 to another with the objective of maintaining the continuity of the call. A “hand off” is effected by tuning the base station 16 and cellular or PCS phone 32 transmitters and receivers from one set of channels 34; to a different, non-interfering set of channels 34ⱼ in the next adjacent cell 36. Because the network is constrained in bandwidth and number of channels 34, the particular frequency pairs 34-1, 34-2 . . . 34-n have to be coordinated from cell 36 to cell 36 to prevent interference and blocking. Sometimes the hand off is not effected and the call is dropped. The user must then re-initiate the call. In so doing, he or she gets a new channel pair assignment from those available at that time.

The frequency bands 30 in which traditional wireless communications systems operate are sufficiently small that the transmission propagation characteristics do not vary significantly across the band 30, and these propagation characteristics are well understood band-to-band. Transmission continuity and integrity is affected by all of the traditional parameters, including but not limited to for example, FCC regulations, transmitter power, antenna gain, noise, multipath, receiver sensitivity and selectivity, and the like.

Transmission continuity and integrity is established and maintained by getting the signal from the base station 16 to the user 12, 32 and from the user 12, 32 to the base station 16 by providing signal coverage with adequate link margin. Constrained to a particular frequency band 30, accomplishing this can mean installing additional base stations 16, aligning base station 16 antennas to accommodate particular transmission situations, or other techniques well known in the cellular and PCS industries.

A network operating in multiple frequency bands with varying propagation characteristics would be particularly advantageous in addressing the “lack of coverage” and “dropped call” problems, quality of service (“QOS”) issues.

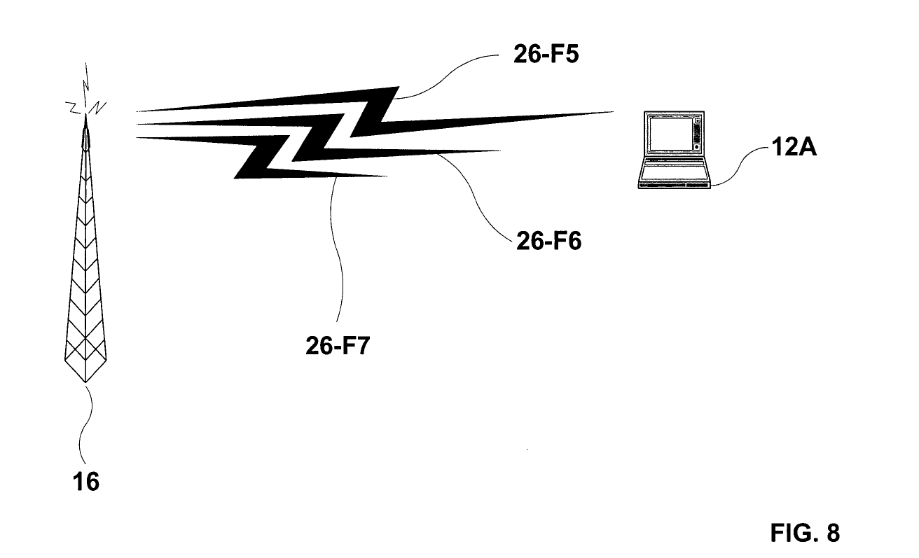

FIG. 8 shows a base station 16 simultaneously transmitting on three RF frequencies 26-F5, 26-F6, 26-F7. If the user terminal 12A is capable of receiving all three RF frequencies 26-F5, 26-F6, 26-F7, then information can be transmitted to the user with a high degree of reliability because the user terminal 12A can utilize “the best” or an “aggregate of” the three frequencies 26-F5, 26-F6, 26-F7, depending upon the particular technique implemented. The same is true in reverse from the user terminal 12A to the base station 16. The disclosed invention 10 comprises a network in which the plurality of base stations 16 transmit and receive on a plurality of RF frequencies 26 as do the user terminals 12.

Consider three (3) selected frequency bands in the ISM and Unlicensed National Information Infrastructure (“U-NII”) bands: 902 to 928 MHz 26-F5, 2400 to 2483.5 MHz 26-F6 and 5725 to 5825 MHz 26-F7 as shown in FIG. 8. For the purposes of the discussion that follows, assume that the base stations 16 and user terminals 12 are capable of transmitting and receiving all three selected frequency bands.

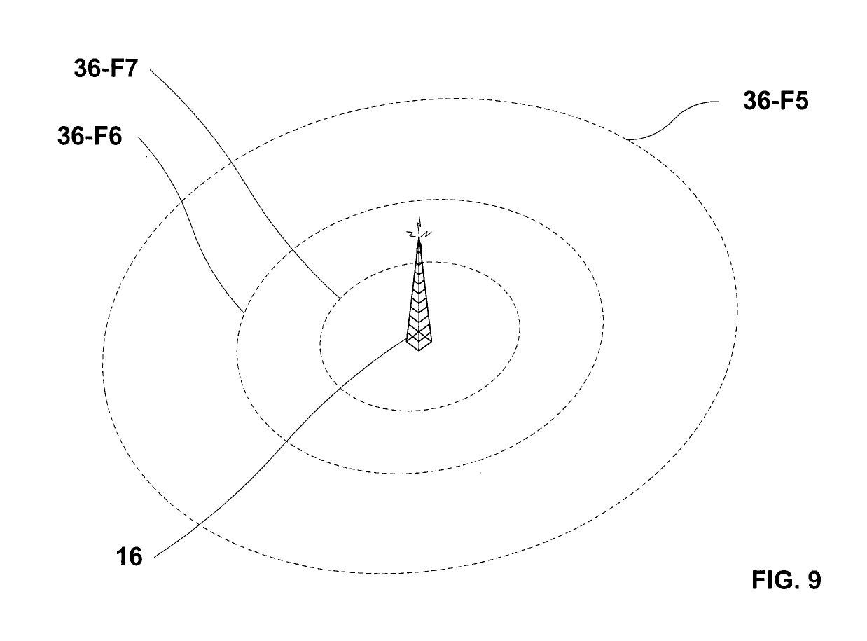

Table 1 shows the line-of-sight (“LOS”) link budget for a 1 Mbps data transmission in each of the selected bands 26-F5, 26-F6, 26-F7. The LOS calculations assume a 1 watt transmitter power, a transmitter antenna gain of 6 dBi and a receiver antenna gain of 0 dBi in each of the selected bands. The link margin in each selected frequency band is approximately 3 dB. Table 1 shows that the signal can be expected to propagate about 100 miles at 900 MHz 26-F5, 37 miles at 2.4 GHz 26-F6, and 16 miles at 5.7 GHz 26-F7. The signal propagation characteristics at 900 MHz are significantly different than those at 2.4 GHz and even more different than those at 5.7 GHz. “Stacking” or “tiering” these three (3) RF frequencies on a base station 16 and in a user terminal 12 provides three (3) overlapping coverage areas 36-F5, 36-F6, 36-F7 with a set of three (3) independent propagation characteristics as shown in FIG. 9.

TABLE 1
Line-of-Sight Link Budget for Selected ISM and U-NII Bands

| | | 900 MHz | 2.4 GHz | 5.7 GHz |
|---|---|---|---|---|
| Transmit Frequency | GHz | 0.90 | 2.40 | 5.72 |
| Transmitter Power | Watts | 1 | 1 | 1 |
| Transmitter Power | dBm | 30.0 | 30.0 | 30.0 |
| Transmitter Antenna Gain | dBi | 6.00 | 6.00 | 6.00 |
| Effective Radiated Power | dBm | 36.0 | 36.0 | 36.0 |
| Noise Temperature Total | K | 800.00 | 800.00 | 800.00 |
| for Receiver | | | | |
| Total Receiver Antenna Gain | dBi | 0.00 | 0.00 | 0.00 |
| Path Length/Slant Range | mi | 100.00 | 37.00 | 16.00 |
| Basic Transmission Loss | dB | 135.72 | 135.60 | 135.86 |
| Other Losses | dB | 1.00 | 1.00 | 1.00 |
| Median Received Signal | dBm | −100.72 | −100.60 | −100.86 |
| Level | | | | |
| Boltzman's Constant | dBW | 1.38E−23 | 1.38E−23 | 1.38E−23 |
| Thermal Noise per Hz | dBm | −169.57 | −169.57 | −169.57 |
| of Bandwidth | | | | |
| Data Rate | Mbps | 1.00 | 1.00 | 1.00 |
| Data Rate in dB | dB | 6.0 | 6.0 | 6.0 |
| Receiver Noise Threshold | dBm | −109.57 | −109.57 | −109.57 |
| C/N in IF Bandwidth | dB | 8.85 | 8.97 | 8.71 |
| Implementation Loss | dB | 0.00 | 0.00 | 0.00 |
| E_{b}/Nₒ | dB | 8.85 | 8.97 | 8.71 |
| Bit Error Rate | | 1E−05 | 1E−05 | 1E−05 |
| Minimum E_{b}/Nₒ Required | dB | 6.0 | 6.0 | 6.0 |
| Link Margin | dB | 2.85 | 2.97 | 2.71 |

The use of tiered frequencies in a wireless communications network has numerous implications for coverage, potential number of users accommodated, system implementation cost, and QOS. These implications are best illustrated by a specific example.

A number of assumptions are required to estimate the prospective capacity of a tiered network using the frequency bands discussed above 26-F5, 25-F6, 26-F7. A total of 26 MHz is available at 900 MHz 26-F5, 83.5 MHz at 2.4 Ghz 26-F6, and 100 MHz at 5.7 Ghz 26-F7. The nominal download “channel equivalent” bandwidth is assumed to be 1 Mbps, and each frequency band divided into 1 Mbps “channels” of 5 MHz each. (This ratio between data rate and frequency spread has been shown to give good frequency control and energy spread.) Ninety-five percent (95%) of channel capacity is assumed to be download capacity, and five percent (5%) upload because these channels can be much smaller. Projected network capacities are based solely upon 1 Mbps download channels. The resulting number of download channels in each frequency band is shown in Table 2.

TABLE 2
Equivalent 1 Mbps Download Channels Per Base Station

| Frequency Band | Download 1 Mbps Channels per Base Station |
|---|---|
| 900 MHz | 5 |
| 2.4 GHz | 16 |
| 5.7 GHz | 20 |

Table 1 shows the LOS link calculation for a 1 Mbps signal in the frequency bands 902-928 MHz 26-F5, 2400-2483.5 MHz 26-F6 and 5725-5825 MHz 26-F7. For coverage analysis purposes the propagation has been reduced by an order of magnitude in each band as shown in Table 3.

TABLE 3
Assumed Propagation Per Frequency Band

| Frequency Band | Assumed Propagation |
|---|---|
| 900 MHz | 10 mi |
| 2.4 GHz | 3.7 mi |
| 5.7 GHz | 1.6 mi |

Assume a network to cover approximately one thousand square miles (1,000 mi²), an area about thirty-three miles (33 mi) by thirty-three miles (33 mi), approximately the size of the San Diego Metropolitan Area. The number of base stations 16 required in each frequency band 26-F5, 25-F6, 26-F7 to cover this area is shown in Table 4.

TABLE 4
Base Stations Required Per Frequency Band

| Frequency Band | Required Base Stations |
|---|---|
| 900 MHz | 3 |
| 2.4 GHz | 23 |
| 5.7 GHz | 124 |

The above assumes circular cells 36 with non-sectorized antennas. In contrast to traditional wireless communications systems where the channel frequencies 32-1 . . . 32-n have to be coordinated from cell 36 to cell 36, the ability of the disclosed invention 10 to simultaneously impress the same digital input 24 upon multiple RF frequencies without channelization means that all channels are available in all cells 36.

Multiplying the minimum required number of base stations 16 by the download capacity per base station yields the total available download channels in the thousand square mile area as shown in Table 5. Table 5 also shows the potential total number of users assuming ten (10) users per channel, a very conservative assumption.

TABLE 5
Total Available Download Channels and Users in One Thousand
Square Miles

| Frequency Band | Total Download Channels | Total Users |
|---|---|---|
| 900 MHz | 15 | 150 |
| 2.4 GHz | 368 | 3,680 |
| 5.7 GHz | 2,480 | 24,800 |

The use of sectorized antennas and lower power transmitters can dramatically increase the total number of available channels. Table 6 shows the tremendous growth in available channel capacity using sectorized antennas. Table 6 assumes that every base station 16 utilizes the particular sectorized antenna.

TABLE 6
Total Available Download Channels in One Thousand Square Miles
Using Sectorized Antennas

| | 900 MHz | 2.4 GHz | 5.7 GHz |
|---|---|---|---|
| | Channels | | |
| Half-Sector Antennas | 30 | 736 | 4,960 |
| Tri-Sector Antennas | 45 | 1,104 | 7,440 |
| Quad-Sector Antennas | 60 | 1,472 | 9,920 |
| | Loaded Users | | |
| Half-Sector Antennas | 300 | 7,360 | 49,600 |
| Tri-Sector Antennas | 450 | 11,040 | 74,400 |
| Quad-Sector Antennas | 600 | 14,720 | 99,200 |

In deploying an actual network a variety of sectorized antennas would be utilized along with omnidirectional antennas. Therefore, the actual number of available channels would range from those shown in Table 5 to those shown in Table 6.

Another way of increasing the number of users per channel is multiplexing. A multiplexing factor of five (5) is considered possible. Therefore, the number of channels per base station increased proportionately as shown in Table 7.

TABLE 7
Total Available Download Channels and Users
as a Function of Multiplexing Factor

| | Multiplexing Factor | | |
|---|---|---|---|
| | 1 | 3 | 5 |
| Frequency Band | 1 Mbps Channels per Base Station | | |
| 900 MHz | 5 | 15 | 25 |
| 2.4 GHz | 16 | 48 | 80 |
| 5.7 GHz | 20 | 60 | 100 |

Therefore, the number of 1 Mbps channels and number of users shown in Tables 2, 5 and 6 can increase by a factor of up to five (5). For example, Table 8 shows the total number of available 1 Mbps download channels and total users with a multiplexing factor of five (5).

TABLE 8
Total Available Download Channels and Users in
One Thousand Square Miles with a Multiplexing Factor of Five (5)

| Frequency Band | Total Download Channels | Total Users |
|---|---|---|
| 900 MHz | 75 | 750 |
| 2.4 GHz | 1,840 | 18,400 |
| 5.7 GHz | 12,400 | 124,000 |

The analysis above is based upon a 1 Mbps channel. If the data rate is decreased, the number of available channels increases dramatically as does the number of prospective users. Table 9 shows the LOS link budget for a 256 kbps data transmission in each of the selected bands 26-F5, 26-F6, 26-F7. As above, the LOS calculations assume a 1 watt transmitter power, a transmitter antenna gain of 6 dBi and a receiver antenna gain of 0 dBi in each of the selected bands. The link margin in each selected frequency band is approximately 3 dB.

TABLE 9
Line-of-Sight Link Budget for Selected ISM and U-NII Bands

| | | 900 MHz | 2.4 GHz | 5.7 GHz |
|---|---|---|---|---|
| Transmit Frequency | GHz | 0.90 | 2.40 | 5.72 |
| Transmitter Power | Watts | 1 | 1 | 1 |
| Transmitter Power | dBm | 30.0 | 30.0 | 30.0 |
| Transmitter Antenna Gain | dBi | 6.00 | 6.00 | 6.00 |
| Effective Radiated Power | dBm | 36.0 | 36.0 | 36.0 |
| Noise Temperature Total | K | 800.00 | 800.00 | 800.00 |
| for Receiver | | | | |
| Total Receiver Antenna Gain | dBi | 0.00 | 0.00 | 0.00 |
| Path Length/Slant Range | mi | 100.00 | 37.00 | 16.00 |
| Basic Transmission Loss | dB | 135.72 | 135.60 | 135.86 |
| Other Losses | dB | 1.00 | 1.00 | 1.00 |
| Median Received Signal | dBm | −100.72 | −100.60 | −100.86 |
| Level | | | | |
| Boltzman's Constant | dBW | 1.38E−23 | 1.38E−23 | 1.38E−23 |
| Thermal Noise per Hz | dBm | −169.57 | −169.57 | −169.57 |
| of Bandwidth | | | | |
| Data Rate | Mbps | 0.256 | 0.256 | 0.256 |
| Data Rate in dB | dB | 54.08 | 54.08 | 54.08 |
| Receiver Noise Threshold | dBm | −115.49 | −115.49 | −115.49 |
| C/N in IF Bandwidth | dB | 14.77 | 14.89 | 14.62 |
| Implementation Loss | dB | 0.00 | 0.00 | 0.00 |
| E_{b}/Nₒ | dB | 14.77 | 14.89 | 14.62 |
| Bit Error Rate | | 1E−05 | 1E−05 | 1E−05 |
| Minimum E_{b}/Nₒ Required | dB | 11.71 | 11.71 | 11.71 |
| Link Margin | dB | 3.06 | 3.18 | 2.91 |

A number of assumptions are required to estimate the prospective capacity of a tiered network using the frequency bands discussed above 26-F5, 25-F6, 26-F7. A total of 26 MHz is available at 900 MHz 26-F5, 83.5 MHz at 2.4 Ghz 26-F6, and 100 MHz at 5.7 Ghz 26-F7. The nominal download “channel equivalent” bandwidth is assumed to be 256 kbps, and each frequency band divided into 256 kbps “channels.” Ninety-five percent (95%) of channel capacity is assumed to be download capacity, and five percent (5%) upload because these channels can be much smaller. Projected network capacities are based solely upon 256 kbps download channels. The resulting number of download channels in each frequency band is shown in Table 10.

TABLE 10
Equivalent 256 kbps Download Channels Per Base Station

| Frequency Band | Download 256 kbps Channels per Base Station |
|---|---|
| 900 MHz | 99 |
| 2.4 GHz | 317 |
| 5.7 GHz | 380 |

Multiplying the minimum required number of base stations 16 by the download capacity per base station yields the total available 256 kbps download channels in the thousand square mile area as shown in Table 11. Table 11 also shows the potential total number of users assuming ten (10) users per channel, a very conservative assumption.

TABLE 5
Total Available Download Channels in One Thousand Square Miles

| Frequency Band | Total Download Channels | Total Users |
|---|---|---|
| 900 MHz | 314 | 3,145 |
| 2.4 GHz | 7,378 | 73,778 |
| 5.7 GHz | 47,250 | 472,501 |

The obvious implication of the above analysis is that many more users can be accommodated at the higher frequencies than at the lower ones, and that many more users can be accommodated at lower data rates than at higher ones. To be served at the higher frequencies the users have to be closer to the base stations 16 than at the lower frequencies. The ability of the disclosed invention 10 to dynamically allocate bandwidth in each of the three frequency bands means that a very large number of users may be accommodated. A further implication of the above analysis is that channel saturation or congestion can be reduced by decreasing the data rate available to users within the coverage area of the saturated or congested bass station.

In the disclosed invention 10 transmission to and from a user is always accomplished in the highest frequency band where the link can be established and maintained. If the user moves to a location where the link at the higher frequency cannot be maintained, then the transmission to the user is automatically moved to the next lower frequency band where link continuity and integrity can be maintained.

The disclosed invention 10 also comprises a system to manage initiation and maintenance of communications between users 12 and base stations 16, including both among frequency bands and cell-to-cell.

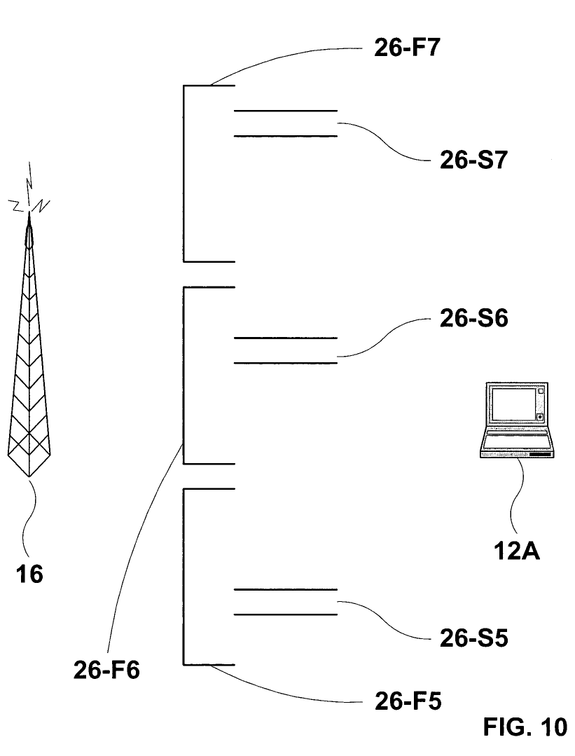

One approach to managing switching from frequency to frequency is to set aside a portion of each frequency band to be used, perhaps exclusively, for control communications between user terminals 12 and base stations 16, a “signaling channel,” as shown in FIG. 10. Signaling channel 26-S5 operates in frequency band 26-F5, signaling channel 26-S6 operates in frequency band 26-F6, and signaling channel 26-S7 operates in frequency band 26-F7.

The transition from a user terminal 12 operating in frequency band 26-F7 to operating in frequency band 26-F6 would be effected by the user terminal 12 sending a message on signaling channel 26-S7 to the base station 16 telling it to move the communications to frequency band 26-F6. The user terminal 12 would cease sending data communications in frequency band 26-F7. Upon receipt of the message, base station 16 would send a message back to user terminal 12 on signaling channel 26-S7 telling the user terminal 12 that it 16 had received the message and telling the user terminal 12 to switch to frequency band 26-F6. After sending the message the base station 16 itself would switch to frequency band 26-F6. After re-tuning the user terminal 12 would then send a confirmation message to base station 16 on signaling channel 26-S6. Upon receipt of the confirmation message on signaling channel 26-S6, the base station 16 would commence data communications with the user terminal 12 in frequency band 26-F6. This same procedure would be followed for all transitions, tip or down, in frequency.

Another approach to managing switching from frequency to frequency is to set aside a portion of one frequency band to be used, perhaps exclusively, for control communications between user terminals 12 and base stations 16.

The 2.4 GHz band 26-F6 is allocated to ISM on a worldwide basis by the International Telecommunications Union (“ITU”). Utilizing only a single signaling channel, the most preferred embodiment of the disclosed invention 10 uses a portion of the 2.4 GHz band for signaling.

The process for switching from one frequency band to another utilizing only a single signaling channel is identical to that described above for multiple signaling channels with the exception that all control communications take place using the single signaling channel. In other words, in addition to whatever frequency band is being used for data communications, all base stations 16 and all user terminals 12 are always tuned to the signaling channel in addition to the data communications frequency band.

Another approach to managing switching from frequency to frequency is to use IP packets addressed to the base station 16 and the user terminal 12. The most preferred embodiment of the disclosed invention 10 utilizes Internet Protocol throughout. In the most preferred embodiment of the disclosed invention each base station 16 and each user terminal 12 has its own IP address. Control communications are IP packets containing frequency band assignment information addressed to the appropriate base station 16 or user terminal 12. No signaling channels are required. Control packets are sent in the frequency band in use for data communications. Network control via IP packet is the most preferred embodiment of the disclosed invention 10.

As described above, one of the most critical issues facing traditional wireless communications systems is maintaining the continuity and integrity of communications while being “handed off” from one base station 16 to another. “Hand off” in the most preferred embodiment of the disclosed invention 10 is much easier than in traditional wireless communications systems.

When a base station 16 is sending IP packets to a user terminal 12 it receives an acknowledgment that each packet is received, and vice versa. If packet acknowledgment is not received, the packet is cached and re-sent until acknowledgment is received within certain operating parameters. Because each user terminal 12 has its own unique IP address, as the user terminal 12 traverses from one cell 36 to another the base stations 16 know where the user terminal 12 is at every point in time. As the user terminal 12 crosses the boundary from one cell 36 to another, the prior base station 16 continues trying to send packets to the user terminal 12 until another base station 16 notifies it that the user terminal 12 is now within its coverage area 36. At that point the prior base station 16 transfers the cached packets to the new base station 16 for delivery to the user terminal 12. In most circumstances the user will not even be aware of the delay in arrival of some packets.

In summary, the characteristics of the network elements of the most preferred embodiment of the disclosed invention 10 comprise a tiered multi-frequency IP network in which asymmetric bandwidth is dynamically allocated according to user demand.

User Terminals

The variety of possible user terminal 12 configurations is shown in FIG. 2, ranging from a laptop computer 12A, PDA 12B, to a terminal installed in an automobile 12C, in a truck 12D, on a train 12E, on a ship or boat 12F, or a fixed terminal 12G. The disclosed invention 10 comprises a receiver and transmitter for the wireless air interface 14, modem and antenna that enables communications between a user terminal 12 and a base station via the wireless air interface 14.

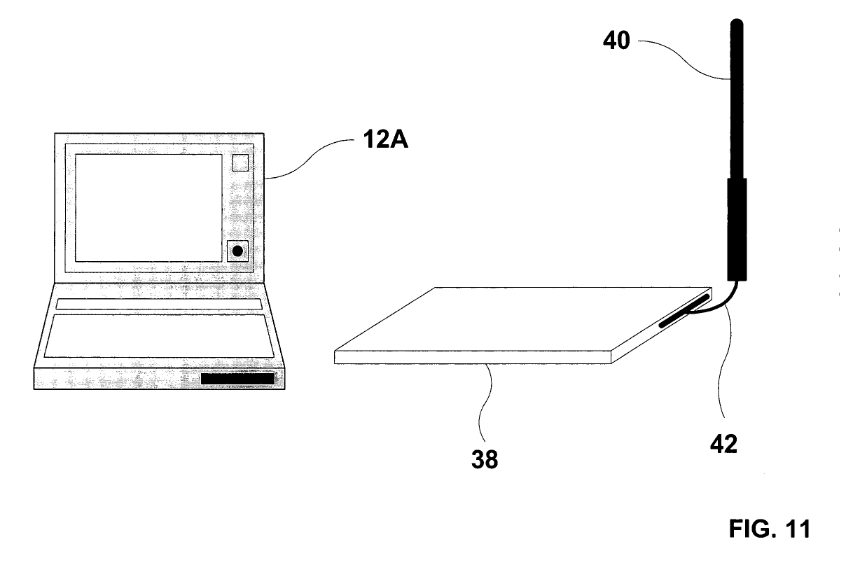

For a laptop computer 12A the receiver, transmitter and modem 38 form factor is a PC card (nee PCMCIA card) with an antenna 40 attached by a flexible connection 42 as shown in FIG. 11. For ease of use, the antenna 40 can be attached to the back of the laptop liquid crystal display (“LCD”) using Velcro® or other form of attachment after the PC card 38 is inserted into the laptop 12A. In the future, the receiver, transmitter and modem chip set(s) may be integrated with the laptop motherboard and the antenna 40 integrated into the side frames of the LCD. The hardware interface to the laptop is a standard Ethernet interface. The software interface to the laptop is the TCP/IP stack in the operating system (“OS”).

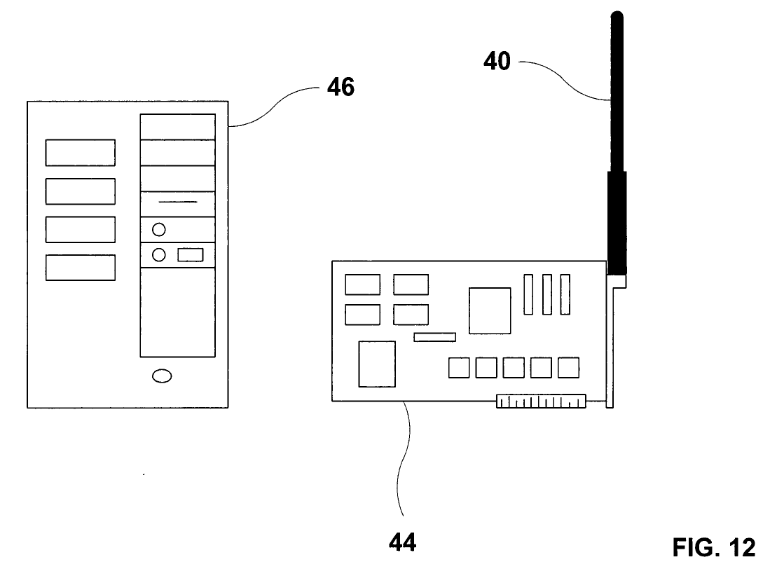

For a fixed terminal 12G the receiver, transmitter and modem 44 form factor is a PCI card for a desktop computer 46 with an antenna 40 rigidly attached as shown in FIG. 12. The antenna connection could also be a swivel ball joint. The hardware interlace to the laptop is a standard Ethernet interface. The software interface is the TCP/IP stack in the OS. The same PCI card or chip set could also be used for home entertainment systems such as stereo systems, televisions or game systems.

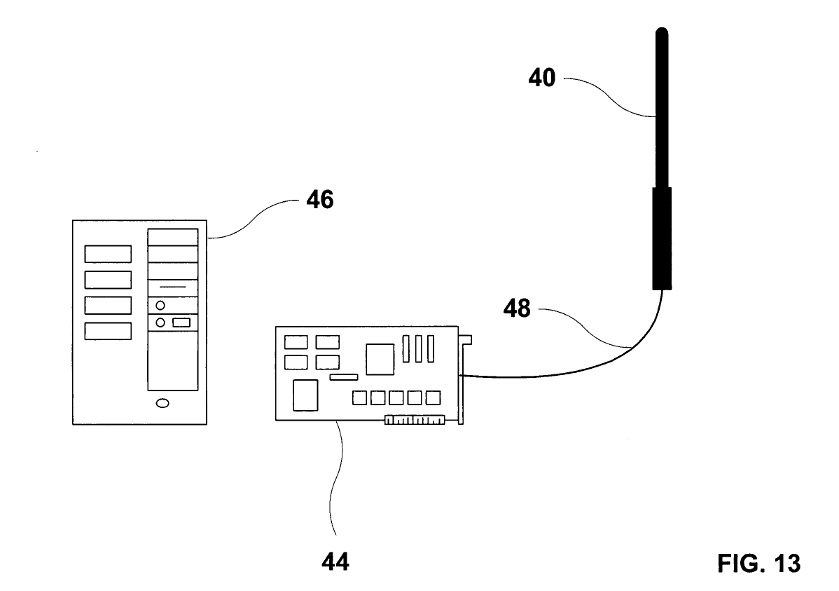

FIG. 13 shows an alternative embodiment of the fixed terminal 12G in which the antenna 40 is mounted remotely, on the roof for example, and connected to the PCI card 44 by a cable 48.

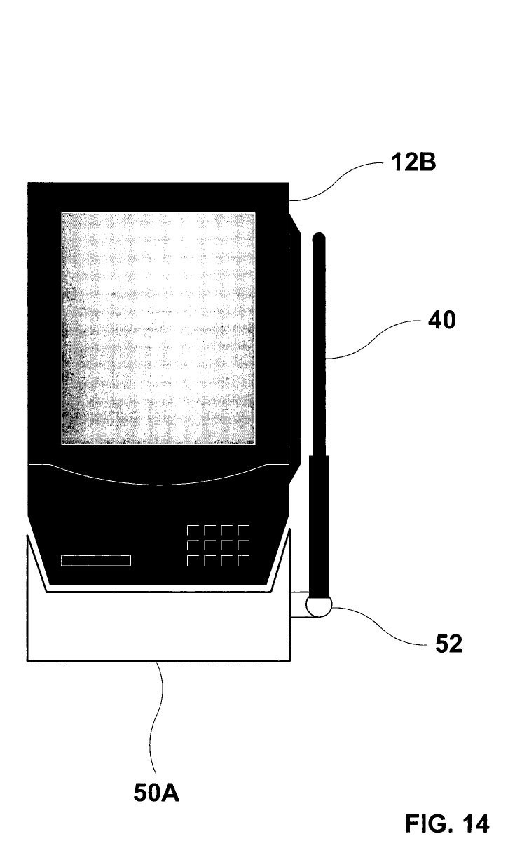

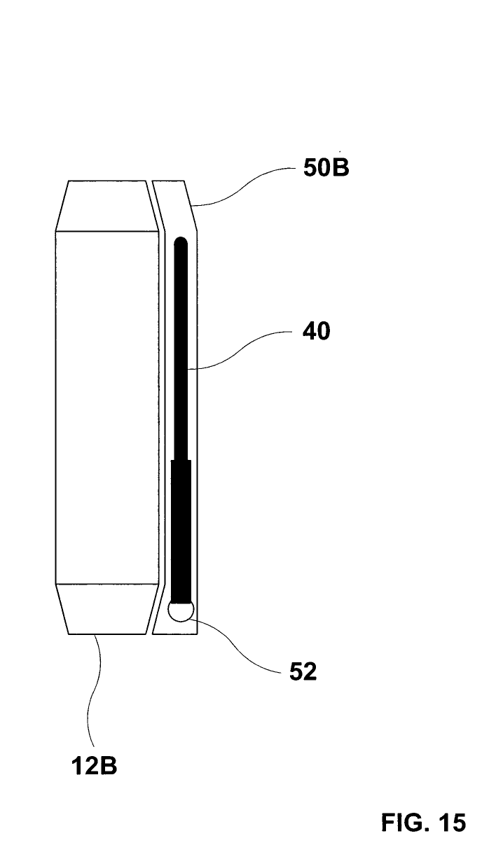

For a PDA 12B one receiver, transmitter and modem 50A form factor is a conformal shape appended to the bottom of the PDA 12B with the antenna 40 appended via a swivel ball joint 52 as shown in FIG. 14. An alternative receiver, transmitter and modem 50B form factor is a conformal shape appended to the back of the PDA 12B with the antenna 40 appended via a swivel ball joint 52 as shown in FIG. 15. The modem 50 hardware interface to the PDA 12B is a standard Ethernet interface, which may have to be modified to a proprietary interface for a particular PDA 12B. The modem 50 software interface is TCP/IP, which may have to be modified to a proprietary OS for a particular PDA 12B.

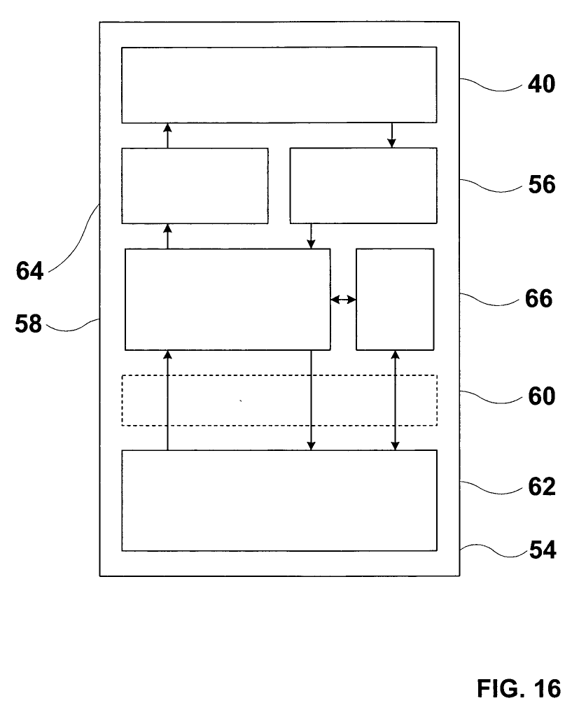

A terminal 54 installed in an automobile 12C, in a truck 12D, on a train 12E, on a ship or boat 12F could look and function like a laptop computer 12A or be more like an existing automotive radio/stereo system or GPS system with a video display for the delivery of IP-based streaming audio and video or images. The block diagram for a user terminal installed in a vehicle 54 is shown in FIG. 16. The wireless air interface 14 signal is received by the antenna 40 and fed to the receiver 56. The signal is then digitally processed 58 under the control of a software operating system 60. The user interacts with the terminal 52 via a user interface 62. Transmissions from the user terminal 54 are likewise software controlled 60 and digitally processed 58 before being fed to the transmitter 64 and the antenna 40. Ancillary systems 66 such as GPS or in-vehicle electronic systems likewise interact with the digital signal processing system 58 and the user interface 62 under control of the OS 60.

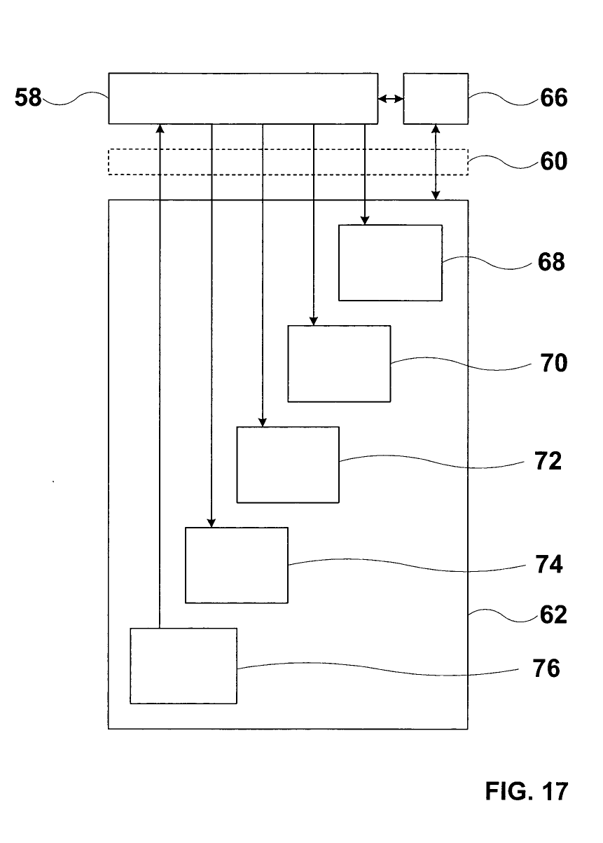

The block diagram for the user interface 62 for a user terminal 12 of the disclosed invention 10 is shown in FIG. 17. The user interface 62 comprises an audio system 68, an image and video system 70, a data output system 72, a user display 74, and a data input system 76. These user interface elements 68-76 interact with the digital signal processing system 58 and ancillary system(s) 66 under the control of the OS 60.

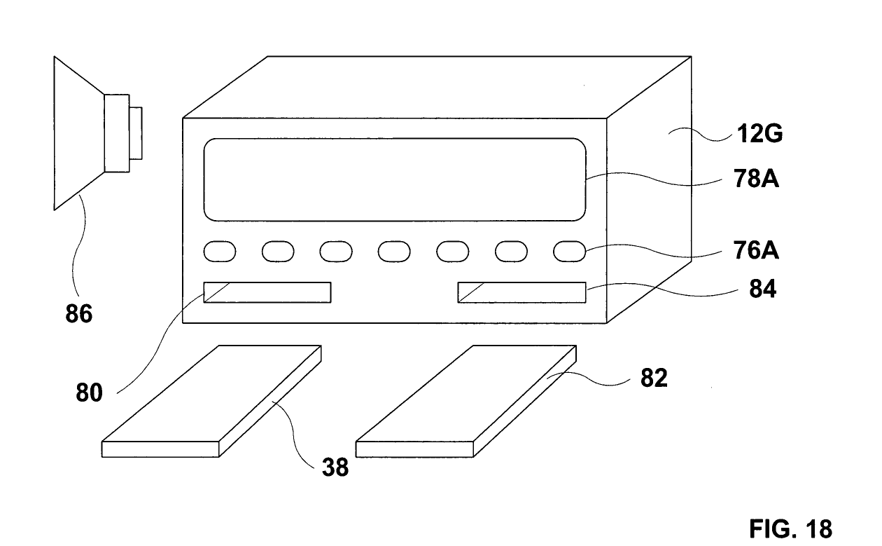

An example of an audio user terminal 12G embodiment of the disclosed invention 10 which might be installed in a vehicle is shown in FIG. 18. The audio user terminal 12G comprises a display 78A which could be a data output system 72 or a full image or video system 70. The display 78A might show the name of the composition, artist, playing time or the like.

The audio user terminal 12G also comprises a data input system 76 which could simply be a plurality of buttons 76A as shown in FIG. 18, or a QWERTY keyboard 76B, a non-QWERTY keyboard, a ten key pad or a multi-stroke entry pad like that developed by Tegic Corporation. The data input system 76 could also comprise a RS 232 port, an infrared (“IR”) port, a fire wire port or a USB port and the programming of the terminal 12G accomplished by a PC, PDA or similar device. The data input system 76 may also comprise a touch screen display 78A or a voice recognition and text to speech system. Any or all of these embodiments of the data input system 76 may be fixed to the terminal or tethered or remote communicating via a wireless link.

In one embodiment the audio user terminal 12G could be enabled by inserting the PC card receiver, transmitter and modem 38 into a PC card slot 80. In an alternative embodiment, the chip set comprising the receiver, transmitter and modem of the disclosed invention 10 would be added to the other electronics enabling the audio user terminal 12G.

The audio user terminal 12G could also comprise a SIM card 82 and SIM card port 84. The SIM card 82 contains, for example, a user profile, listening preferences, subscription information for pay services, programming for the data input system 76 and the display 78, as well as other information. Use of a SIM card 82 allows the user to access his or her preferred programming independent of the particular audio user terminal 12G. For example, a traveling user could carry his or her SIM card 82 to a different city and, by inserting it into an audio user terminal 12G installed in a rental car, enjoy the same programming as in his or her personal vehicle.

The audio programming is delivered to speakers 86 installed in a vehicle either on an original equipment manufacturer (“OEM”) or after-market basis. An antenna 40 for the audio user terminal 12G would be mounted remotely.

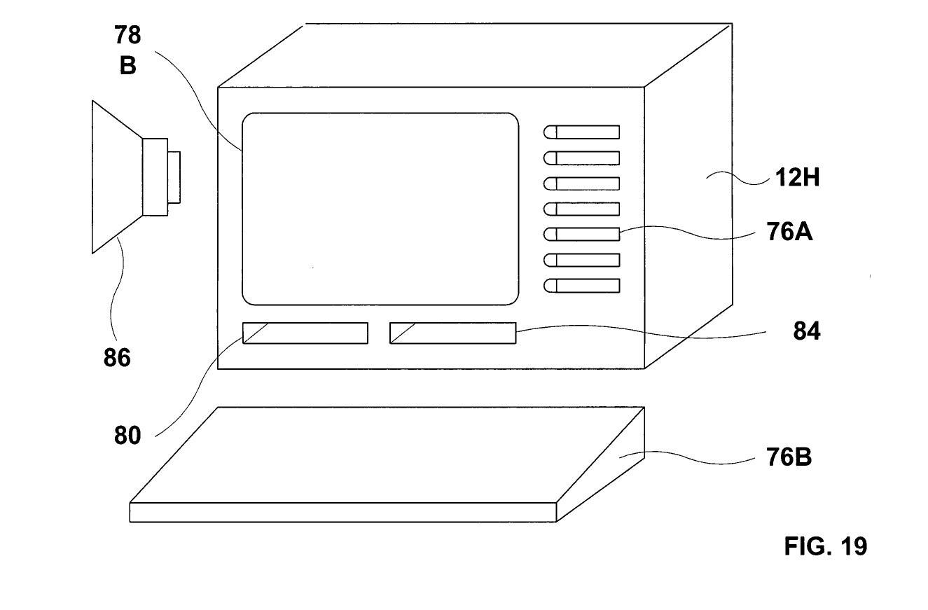

FIG. 19 shows an image or video user terminal 12H embodiment of the disclosed invention 10 which might be installed in a vehicle. The image or video user terminal 12H comprises a display 78B for a full image or video system 70.

The embodiment of the image or video user terminal 12H shown in FIG. 19 comprises three (3) embodiments of a data input system 76: programmable buttons 76A, a QWERTY keyboard 76B and an IR port 76C. Alternative embodiments could comprise a ten key pad, a multi-stroke entry pad like that developed by Tegic Corporation, a RS 232 port, an IR port, a fire wire port, a USB port, a touch screen display 78A, or a voice recognition and text to speech system, just as in the audio user terminal 12G shown in FIG. 18. Any or all of these embodiments of the data input system 76 may be fixed to the terminal or tethered or remote communicating via a wireless link.

The embodiment of the image or video user terminal 12H enables, for example, the following scenario of events. A sensor in an automobile goes out of limit. An alarm message is generated in the ancillary system 66 and transmitted 64 via the Internet 18 to a center operated by the automobile manufacturer. There a technician logs onto the moving vehicle using a Web browser and examines the out-of-limit event. In the center the technician may have on-line access to the engineering drawings and performance parameters of the model or specific vehicle that originated the alarm.

If the out-of-limit condition requires immediate attention, the technician sends a message via the Internet 18 to the vehicle. The message could comprise text on the display 78B or an audio message. Next the technician transmits a map which appears on the display 78B directing the driver to the nearest dealership to have the vehicle repaired.

The image or video user terminal 12H comprises the same functionality as described above for the audio user terminal 12G with respect to the PC card receiver, transmitter and modem 38, chip set, SIM card 82, antenna 40 and audio output.

### Alternative Embodiments

There are a number of alternative embodiments of the disclosed invention 10. A major advantage of a tiered network in the ISM bands is that no FCC license is required, just compliance with the equipment requirements of Part 15 of the FCC Rules. There are a plurality of bands in which a license is required in which the disclosed invention 10 could be deployed, including the existing cellular and PCS bands, the Wireless Communications Service (“WCS”) bands, 2310-2320 and 2345-2360 MHz (S-band) in the United States, the about to be auctioned 746-764 MHz and 776-794 MHz bands, the General Wireless Communications Service (“GWCS”), 4660-4685 MHz, among others. A plurality of the above bands, alone or in conjunction with the ISM bands, could be used to implement the disclosed invention 10 in a tiered network.

The disclosed invention 10 can be implemented in a single frequency band. The dynamic allocation of asymmetric bandwidth characteristics of the disclosed invention 10 can be implemented in a single frequency band, however, the advantages of a tiered network would not be available.

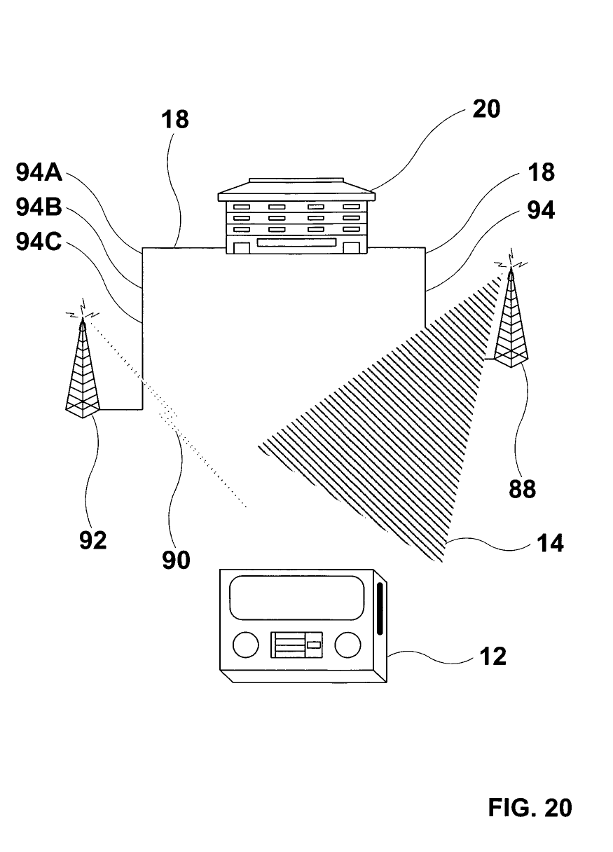

An alternative embodiment of the disclosed invention 10 is shown in FIG. 20. This embodiment comprises a plurality of data broadcasting transmitter systems 88 operating in one or more of the various frequency bands discussed above, the wireless air interface 14; a user terminal 12 capable of receiving the said frequency bands and capable of transmitting in one or more traditional wireless communications bands such as cellular and PCS 90; a plurality of receiving systems 92 for transmission from a user terminal 12; and a NMC 20. In the most preferred embodiment of this alternative embodiment, the transmitter systems are connected to the NMC via the Internet 18. In other embodiments they may be connected via traditional networks 94 such as the Public Switched Telephone Network (“PSTN”) 94A or the Public Switched Data Network (“PSDN”) 94B or via a private network 94C. The receiving systems 92 are connected to the NMC via the Internet 18 or via the traditional networks 94.

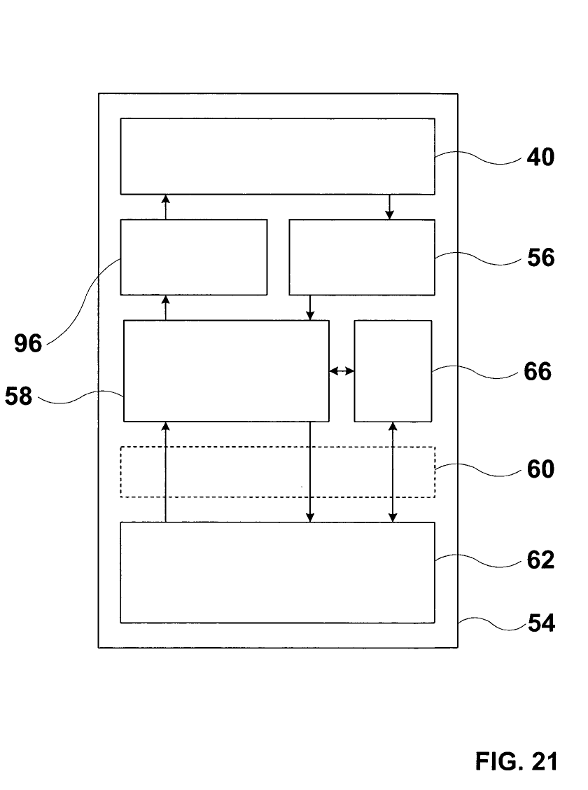

The block diagram for a user terminal 12 for use in this alternative embodiment of the disclosed invention is shown in FIG. 21. The only difference between FIG. 16 and FIG. 21 is the substitution of a traditional wireless communications system transmitter 96 for the wireless air interface transmitter 64.

While this alternative embodiment of the disclosed invention 10 may be used for the plurality of services described above, it may have its greatest applicability in the delivery of audio, video and image services. In this application, the digital data broadcast 14 is much greater in bandwidth than the traditional wireless communication bandwidth 90.

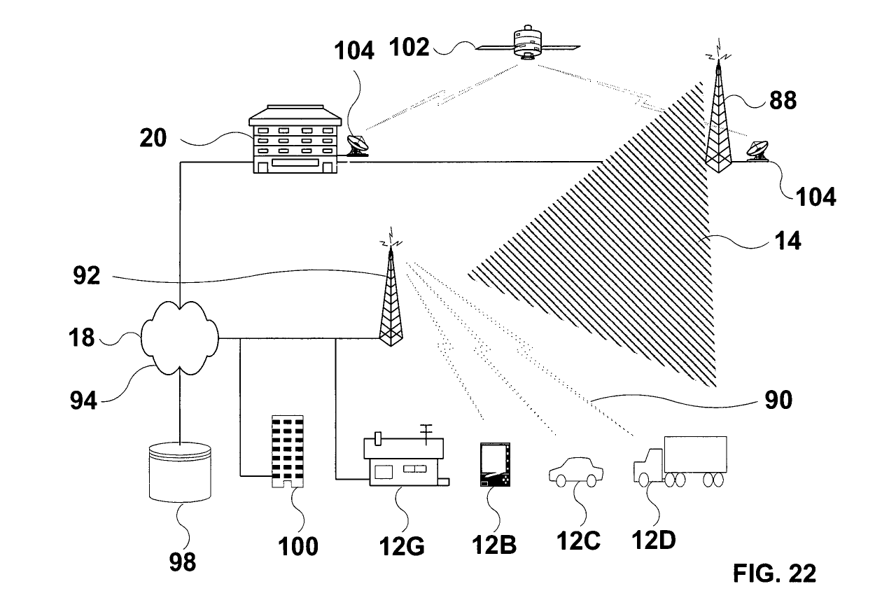

A more comprehensive understanding of the functioning of this alternative embodiment of the disclosed invention may be obtained by examining FIG. 22. Digital audio or video programming or images are created by programming originators 98 and transmitted to the network management center 20 via the Internet 18 or traditional networks 94. There the programming is assembled and prepared for transmission.

The various channels of digital data are then sent via the Internet 18 or traditional networks 94 to the plurality of transmitter systems 88 for broadcast to users. A typical broadcast 14 is comprised of a plurality of “channels” of digital audio, video or images along with concomitant data information such as composition, title, composer name, length remaining and the program publisher. While audio is being played via an audio system 68, concomitant data relating to the audio is displayed on the user interface 62 display 74. Video and images are displayed via the image and video system 70.

If the user wishes to purchase the CD from which an audio selection is taken, he or she touches the appropriate area of the touch-screen display 74. A message is generated by the data input system 76 and transmitted via a traditional wireless communication system 90 to the network management center 20. The network management center 20 then sends the order message via the Internet 18 or via traditional networks 94 to a value-added service provider 100 that fulfills the request and delivers the CD to the user, an electronic commerce application.

In an alternative embodiment of this alternative embodiment of the disclosed invention, a satellite 102 may be employed to distribute signals to the transmitter 66 via satellite earth stations 104 as shown in FIG. 22.

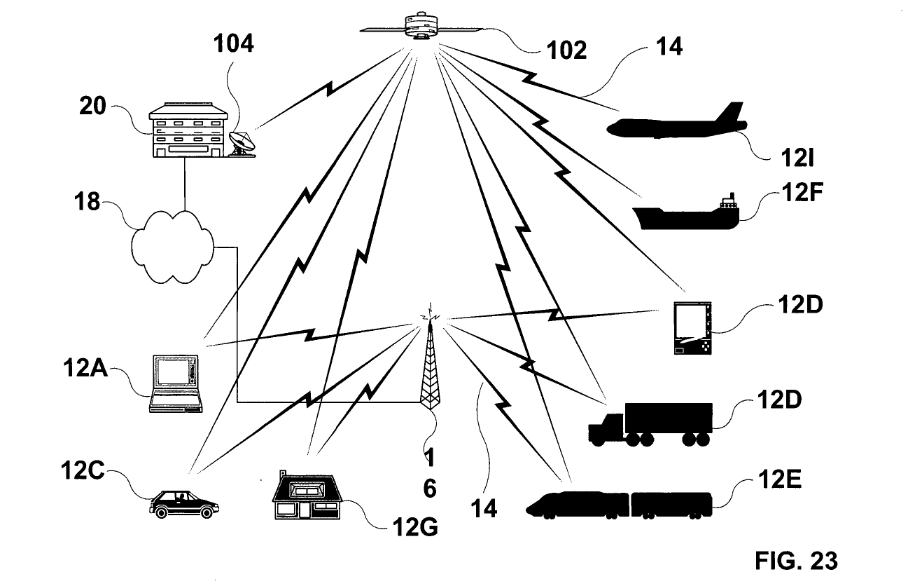

A further alternative embodiment of the disclosed invention 10 is shown in FIG. 23, comprising both satellite and terrestrial communications. In this alternative embodiment user terminals 12 are capable of receiving transmissions from a satellite 102 as well as terrestrial base stations 16. The user terminals 12 are likewise capable of transmitting to a satellite 102 or a terrestrial base station 16. In this alternative embodiment of the disclosed invention 10 services can be provided to user terminals installed in aircraft 12I.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for an interactive digital data broadcasting system that have been disclosed above are intended to educate the reader about preferred embodiments of the invention, and are not intended to constrain the limits of the invention or the scope of Claims. The List of Reference Characters which follow is intended to provide the reader with a convenient means of identifying elements of the invention in the Specification and Drawings. This list is not intended to delineate or narrow the scope of the Claims.

### LIST OF REFERENCE CHARACTERS

10 Interactive Digital Data Broadcasting System
12 User terminal
12A Laptop computer
12B Personal Digital Assistant or Personal Information Manager
12C User terminal in an automobile
12D User terminal in a truck
12E User terminal on a train
12F User terminal on a ship
12G Audio user terminal
12H Image and video user terminal
12I User terminal on an airplane
14 Wireless air interface
16 Base station
18 Internet
20 Network management center
22-T0 Transmission bandwidth at time 0
22-T1 Transmission bandwidth at time 1
22-T2 Transmission bandwidth at time 2
22-T3 Transmission bandwidth at time 3
22-T4 Transmission bandwidth at time 4
24 Digital input data
26-F1 Transmission of data on frequency 1
26-F2 Transmission of data on frequency 2
26-F3 Transmission of data on frequency 3
26-F4 Transmission of data on frequency 4
26-F5 Transmission of data on frequency 5
26-F6 Transmission of data on frequency 6
26-F7 Transmission of data on frequency 7
26-S5 Signaling channel with frequency band F5
26-S6 Signaling channel with frequency band F6
26-S7 Signaling channel with frequency band F7
28 Licensed bandwidth for a traditional wireless communications system
28A Bandwidth for transmitting from a base station to a cellular or Personal Communications System (“PCS”) telephone
28B Bandwidth for transmitting from a cellular or PCS telephone to a base station
30 Frequency band for a traditional wireless communications system
32 Cellular or PCS telephone
34 User terminal software operating system
36 Cell
36-F5 Cell associated with transmission of data on frequency 5
36-F6 Cell associated with transmission of data on frequency 6
36-F7 Cell associated with transmission of data on frequency 7
38 Personal computer (“PC”) card receiver, transmitter and modem for laptop computer
40 Antenna
42 Flexible connector between PC card and antenna
44 PCI card receiver, transmitter and modem for desktop computer
46 Desktop computer
48 Cable to remotely located antenna for PCI card receiver, transmitter and modem
50 PDA receiver, transmitter and modem
50A PDA receiver, transmitter and modem, bottom form factor
50B PDA receiver, transmitter and modem, back form factor
52 Swivel ball connector between receiver, transmitter and modem and antenna
54 In vehicle user terminal block diagram
56 Wireless air interface receiver
58 Digital signal processing
60 Software operating system
62 User interface
64 Wireless air interface transmitter
66 Ancillary system(s)
68 Audio system
70 Image and video system
72 Data output system
74 User display
76 Data input system
76A Programmable buttons
76B QWERTY keyboard
76C Infrared port
78 User terminal display
78A Audio user terminal display
78B Image and video user terminal display
80 PC card slot
82 Subscriber Identity Module (“SIM”) card
84 SIM card port
86 Audio speakers
88 Wireless air interface broadcast base station
90 Traditional wireless communications system communications link
92 Traditional wireless communications system base station
94 Traditional communications networks
94A Public Switched Telephone Network
94B Public Switched Data Network
94C Private network
96 Traditional wireless communications system transmitter
98 Programming originators
100 Value-added service provider
102 Satellite
104 Satellite earth station

### SEQUENCE LISTING

Not Applicable.

1. A communications system comprising:
at least one base station in communication with at least one user terminal;
means for transmitting a signal from said user terminal to said base station in a first predetermined bandwidth (frequency range); and
means for transmitting a signal from said base station to said user terminal in a second predetermined bandwidth (frequency range).

2. The communications system as claimed in claim 1 including network management means for controlling the transmission of said signals, said network management means in communication with said base station.

3. The communications system as claimed in claim 2 further including a global communications network (internet) disposed between said network management means and said base station.

4. The communications system as claimed in claim 1 wherein said first predetermined bandwidth is in the S-band frequencies, and said second predetermined bandwidth has a frequency range of 1 KHz-3 GHz.

5. The communications system as claimed in claim 1 wherein said first predetermined bandwidth has a frequency range of at least one of 2,310-2,320 MHz; 2,345-2,360 MHz; 902-928 MHz; 2,400-2,483.5 MHz; and 5,725-5,825 MHz.

6. The communications system as claimed in claim 1 wherein said first predetermined bandwidth and said second predetermined bandwidth are symmetrical.

7. The communications system as claimed in claim 1 wherein said first predetermined bandwidth and said second predetermined bandwidth are asymetrical.

8. The communications system as claimed in claim 7, wherein said second predetermined bandwidth is larger than said first predetermined bandwidth.

9. The communications system as claimed in claim 7 wherein said first predetermined bandwidth is larger than said second predetermined bandwidth.

10. The communications system as claimed in claim 7 wherein said system comprises a plurality of said user terminals.

11. The communications system as claimed in claim 10 wherein said system comprises a plurality of said base stations.

12. The communications system as claimed in claim 1 including means for varying said first predetermined bandwidth.

13. The communications system as claimed in claim 1 including means for varying said second predetermined bandwidth.

14. The communications system as claimed in claim 1 wherein said first and second predetermined bandwidths are allocated to a first geographical zone defined within a first predetermined distance relative to said base station, and third and fourth predetermined bandwidths are allocated for transmitting signals from said user terminal to said base station and from said base station to said user terminal, respectively; said third and fourth predetermined bandwidths operating in a second geographical zone defined within a second predetermined distance relative to said base station.

15. The communications system as claimed in claim 14 wherein said first geographical zone is adjacent to said second geographical zone.

16. The communications system as claimed in claim 14 including means for switching signals transmitted from said user terminal to said base station from said first predetermined bandwidth to said third predetermined bandwidth.

17. The communications system as claimed in claim 14 including means for switching signals transmitted from said base station to said user terminal from said second predetermined bandwidth to said fourth predetermined bandwidth.

18. A communications system comprising: at least one base station in communication with at least one user terminal;
means for transmitting a signal from said user terminal to said base station in a first predetermined bandwidth (frequency range);
means for transmitting a signal from said base station to said user terminal in a second predetermined bandwidth (frequency range);
said first predetermined bandwidth and said second predetermined bandwidth being asymmetrical;
said first and second predetermined bandwidths being allocated to a first geographical zone defined within a first predetermined distance relative to said base station; and
third and fourth predetermined bandwidths being allocated for transmitting signals from said user terminal to said base station and from said base station to said user terminal, respectively; said third and fourth predetermined bandwidths being asymmetrical; said third and fourth predetermined bandwidths being allocated to a second geographical zone defined within a second predetermined distance relative to said base station.

19. A method for transmitting a signal from a base station to a user terminal, and for transmitting a signal from a user terminal to a base station, the steps of said method including:
transmitting a signal from said user terminal to said base station in a first predetermined bandwidth (frequency range);
transmitting a signal from said base station to said user terminal in a second predetermined bandwidth (frequency range); and
selecting said first and second predetermined bandwidths such that they are asymmetrical relative to each other.

20. The method as claimed in claim 19 including the step of allocating said first and second predetermined bandwidths to a first geographical zone defined within a first predetermined distance relative to said base station; and
allocating third and fourth predetermined bandwidths for transmitting a signal from said user terminal to said base station, and for transmitting a signal from said base station to said user terminal, respectively, within a second geographical zone defined within a second predetermed distance relative to said base station.
